(19) United States
(12) Patent Application Publication
(10) Pub. No.: US 2013/0120548 A1
(43) Pub. Date: May 16, 2013

(54) ELECTRONIC DEVICE AND TEXT READING GUIDE METHOD THEREOF

(71) Applicants: HAI-SHENG LI, Shenzhen City (CN); ZHEN-WANG BAO, Shenzhen City (CN); CHIH-SAN CHIANG, Tu-Cheng (TW); GANG TANG, Shenzhen (CN)

(72) Inventors: HAI-SHENG LI, Shenzhen City (CN); ZHEN-WANG BAO, Shenzhen City (CN); CHIH-SAN CHIANG, Tu-Cheng (TW); GANG TANG, Shenzhen (CN)

(73) Assignees: HON HAI PRECISION INDUSTRY CO., LTD., New Taipei (TW); HONG FU JIN PRECISION INDUSTRY (ShenZhen) CO. LTD., Shenzhen City (CN)

(21) Appl. No.: 13/441,006

(22) Filed: Apr. 6, 2012

(30) Foreign Application Priority Data
Nov. 16, 2011 (CN) 201110363256.5

(51) Int. Cl. H04N 7/18

(52) U.S. Cl. 348/78; 348/E07.085

(57) ABSTRACT

A text reading guide method for an electronic device including a display screen and a storage unit is provided. The storage unit stores a database recording a number of feature values of images and a plurality of coordinates. Each coordinate corresponds to a display region of the display screen and is associated a corresponding feature value. The method includes the following steps: capturing a real-time eye image of a user; extracting an eye image feature value from the captured eye image; searching the database to find the eye image feature value of the user matching the extracted eye image feature value, and retrieving the coordinates associated with the eye image feature value; determining the display content on the display region corresponding to the retrieved coordinates; and displaying the determined contents in a highlight fashion on the display screen. An electronic device using the method is also provided.

### BACKGROUND

1. Technical Field

The present disclosure relates to an electronic device and a text reading guide method for the electronic device.

2. Description of Related Art

Many electronic devices, e.g., mobile phones, computers, electronic readers (e-reader), are capable of storing and displaying electronic documents (e.g., digital images, digital texts, for example). Users may manually control the displayed pages of an electronic document on these electronic devices to flip. However, many of the electronic documents include a number of pages, and usually the pages are displayed on the electronic device one at a time. Thus, the user should press the page flipping keys many times to flip through the pages, which is inconvenient especially when a large number of pages need to be displayed. Although some of the electronic devices can automatically flip through the pages when the flipping frequency has been preset by the user. However, the user must finish reading each page before the displayed pages are flipped during the preset time period, otherwise, the electronic device still flips without waiting the user to finish reading.

Therefore, what is needed is an electronic device and a text reading guide method thereof to alleviate the limitations described above.

### BRIEF DESCRIPTION OF THE DRAWINGS

The components in the drawings are not necessarily drawn to scale, the emphasis instead being placed upon clearly illustrating the principles of an electronic device and a text reading guide method for the electronic device. Moreover, in the drawings, like reference numerals designate corresponding sections throughout the several views.

FIG. 1 is a block diagram of an electronic device in accordance with an exemplary embodiment.

FIG. 2 is a posture feature database stored in the storage unit of the electronic device of FIG. 1.

FIG. 3 is a flowchart of a text reading guide method for electronic devices, such as the one of FIG. 1, in accordance with the exemplary embodiment.

FIG. 4 is a schematic diagram of the electronic device of FIG. 1, showing the user interface for the text reading guide, in accordance with an exemplary embodiment.

### DETAILED DESCRIPTION

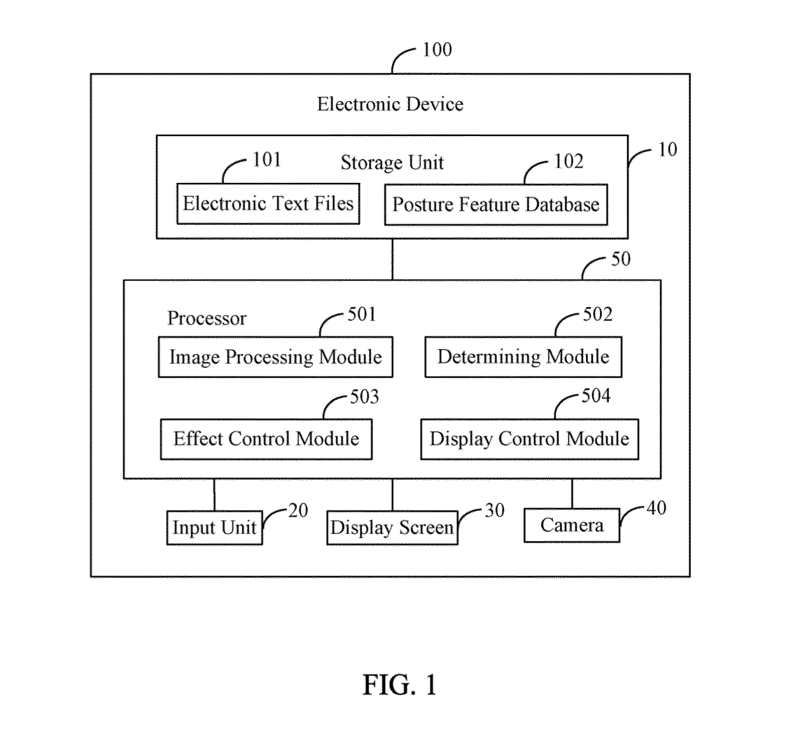

FIG. 1, is an exemplary embodiment of an electronic device 100. The electronic device 100 adjusts the text for reading according to the perspective of the eyes of the user. In the embodiment, the electronic device 100 is an electronic reader with a camera 40. In alternative embodiments, the electronic device 100 can be another electronic device with cameras, such as a mobile phone or a tablet, for example.

The electronic device 100 includes a storage unit 10, an input unit 20, a display screen 30, a camera 40, and a processor 50.

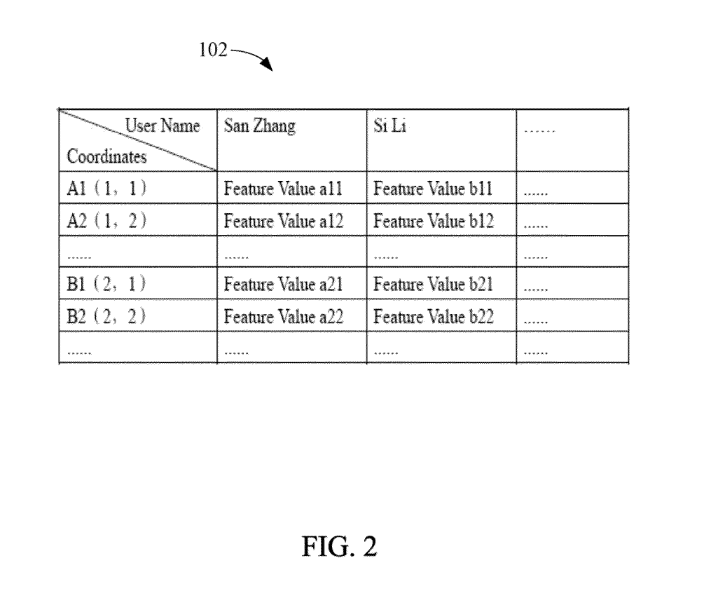

Together referring to FIG. 2, the storage unit 10 stores a plurality of electronic text files 101. The electronic text file 101 includes a text page. The storage unit 10 further stores a posture feature database 102 recording with at least one user's data and a number of coordinates of the display screen 30. Each user's data includes a user name, a number of feature values of images of eyes of the user, and the relationship between each of a set of coordinates of the display screen 30 and each of the feature values of images of eyes of the user. In the embodiment, each of the coordinates corresponds to a display region of the display screen and is associated with a corresponding feature value. The number of feature values of images of eyes of the user reflect lines of sight of the eyes of the user when the user focuses at different coordinates of the display screen 30. The feature values of the images of the eyes of the user are different when the user focuses at different coordinates. In an alternative embodiment, the posture feature database 102 further records a highlight fashion predefined by the user. The highlight fashion is selected from the group comprising enlarging the words, coloring the words, underlining the words, and displaying the words with a font different from the words in neighboring region, for example. In the embodiment, the highlight fashion is different from the default displaying style of the display screen 30, to produce a marking effect on words under the text reading guide function, thus to distinguish the words from other words not marked. The data in the posture feature database 102 is gathered via a navigation interface when the electronic device 100 is powered on and the text reading guide function of the electronic device 100 is activated, which will be explained later in this specification.

The input unit 20 receives user operations and generates operation signals accordingly. The user operations include activating, executing and ending the text reading guide function of the electronic device 100, and setting the text reading guide function, for example.

The camera 40 captures a user's real-time eye images and transmits the eye images to the processor 50. In the embodiment, the camera 40 is secured on the middle top of the display screen 30 for capturing images of eyes of the user, and the camera 40 is activated as long as the text reading guide function of the electronic device 100 is activated via the input unit 20. In alternative embodiments, the camera 40 is secured on the middle left or other portions of the display screen 30, as long as the camera 40 can capture the eye images of the user.

The processor 50 includes an image processing module 501, a determining module 502, an effect control module 503, and a display control module 504.

The image processing module 501 analyzes and processes the eye images by running a variety of image processing algorithms, thus extracting the eye image feature values from the captured eye images of the eyes of the user.

The determining module 502 searches the posture feature database 102 to find the eye image feature value of the user matching with the extracted eye image feature value of the user. The determining module 502 is further configured to retrieve the coordinates associated with the eye image feature value recorded in the posture feature database 102, and to transmit the retrieved coordinates to the effect control module 503.

The effect control module 503 determines the display content such as words, phrases or sentences on the display region corresponding to the retrieved coordinates on the display screen 30, according to the type of the text reading guide effects predefined by the user or the system of the electronic device 100. For example, the mark is zooming, coloring, or underlining the display content on the display region, for example.

The display control module 504 displays the determined contents in a highlight fashion on the display screen 30.

In use, when a user activates the text reading guide function of the electronic device 100 via the input unit 20, the display control module 504 controls the display screen 30 to display an information input box for the user to input a user name. The determining module 502 determines whether the posture feature database 102 records the user name and corresponding user's data. If the posture feature database 102 records the user name and the corresponding user's data, the image processing module 501, the determining module 502, the effect control module 503, and the display control module 504 cooperate to execute the text reading guide function.

When the determining module 502 determines the user name and the corresponding user's data do not exist in the posture feature database 102, that means it is the first time for the user to use the text reading guide function of the electronic device 100. The display control module 504 controls the display screen 30 to display a dialog box prompting the user to determine whether to do a test for recording eye image feature values of his/her eye images. If the user determines to do the test, the display control module 504 further controls the display screen 30 to display the test page of the electronic text file 101. In the embodiment, the content of the test page includes a number of different portions. The display screen 30 defines a coordinate system. Each portion of the test page is displayed on a corresponding display region with coordinates associated therewith. The display control module 504 also controls the display screen 30 to display a dialog box prompting the user to follow the highlighted contents.

In the embodiment, each portion of the test page corresponds to a coordinate of the display screen 30. The camera 40 captures eye images of the user when the user focuses on a portion, and transmits the eye image to the image processing module 501. The image processing module 501 is further configured to extract the eye feature values of the eye image of the user, and to store the extracted eye feature values corresponding to the user name and the coordinates of the display screen 30 respectively in the posture feature database 102. When all portions are finished being read, the test is completed, then the user can activate the text reading guide function of the electronic device 100.

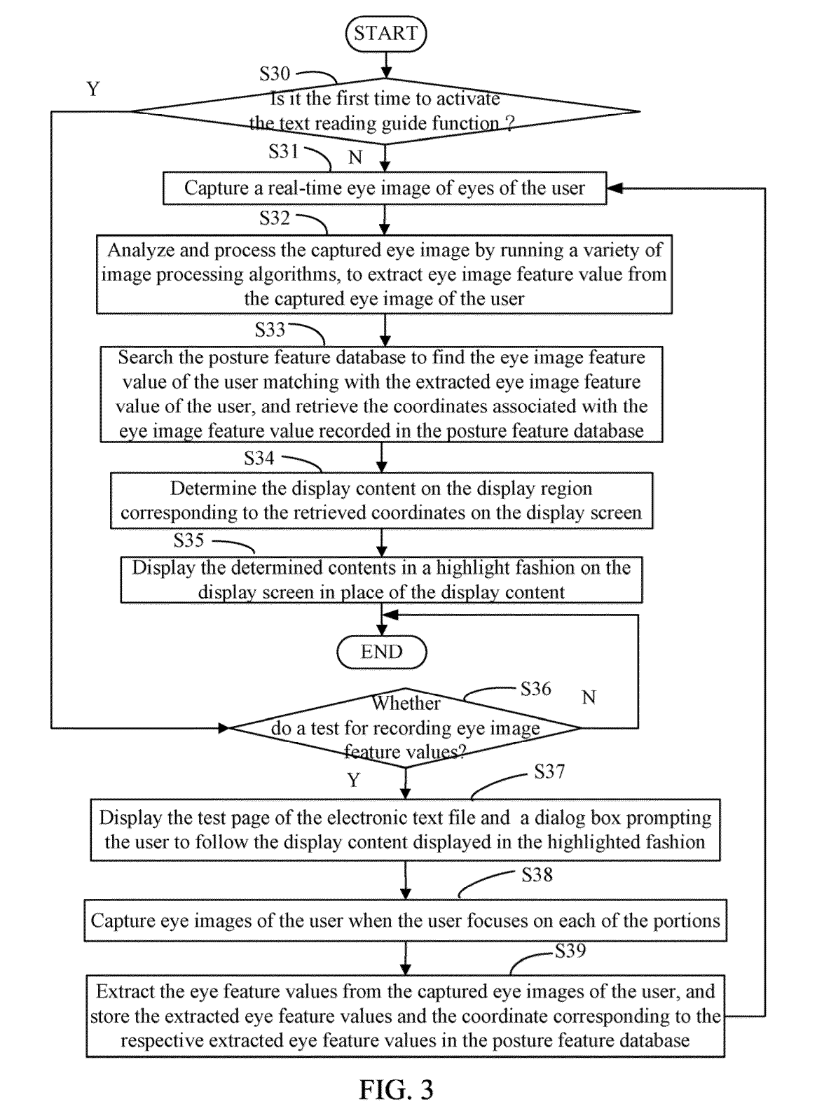

Referring to FIG. 3, a flowchart of a text reading guide method of the electronic device 100 of FIG. 1 is shown. The method includes the following steps, and each of which is connected to the various components contained in the electronic device 100.

In step S30, a user activates the text reading guide function of the electronic device 100, the determining module 502 determines whether it is the first time for the user to activate the text reading guide function, if no, the process goes to step S31, otherwise, the process goes to step S36. In this embodiment, if the user name input by the user exists in the posture feature database 102, the determining module 502 determines it is not the first time for the user to activate the text reading guide function, otherwise, the determining module 502 determines it is the first time for the user to activate the text reading guide function. In the embodiment, the camera 40 is activated when the user activates the text reading guide function.

In step S31, the camera 40 captures a real-time eye image of eyes of the user.

In step S32, the image processing module 501 analyzes and processes the captured eye image by running a variety of image processing algorithms, to extract an eye image feature value from the captured eye image of the user.

In step S33, the determining module 502 searches the posture feature database 102 to find the eye image feature value of the user matching with the extracted eye image feature value of the user, and retrieves the coordinates associated with the eye image feature value recorded in the posture feature database 102. In an alternative embodiment, the determining module 502 searches the posture feature database 102 to find an eye image feature value with a highest similarity to the extracted eye image feature value of the user, and retrieves the coordinates associated with the eye image feature value recorded in the posture feature database 102, when the eye image feature value of the user matching with the extracted eye image feature value of the user is not found in the database.

In step S34, the effect control module 503 determines the display content such as words, phrases, or sentences on the display region corresponding to the retrieved coordinates on the display screen 30, according to a predefined type of text reading guide effect.

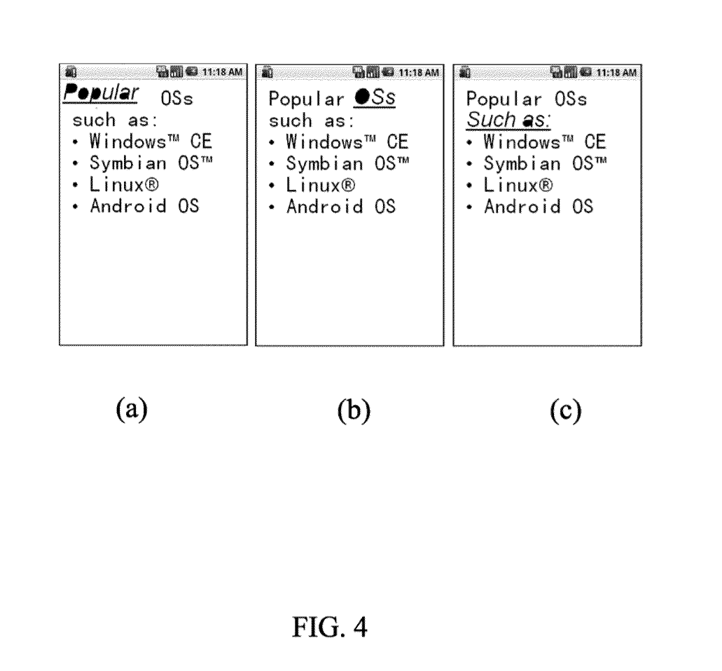

In step S35, the display control module 504 displays the determined contents in a highlight fashion on the display screen 30 in place of the display content. Referring to FIG. 4, the figures (a)-(c) each show different formats of different parts of the same text. The real-time eye image feature values of images of eyes of the user corresponding to three coordinates are extracted, and the display content corresponding to the coordinates are marked. That is, the display content—“Popular”, “OSs”, and “Such as” are respectively underlined, displayed in italics, and filled with black in the enclosed areas.

In step S36, if it is the first time for the user to activate the text reading guide function, the determining module 502 determines whether the user agrees to do a test for recording eye image feature values of his/her eye images, if yes, the process goes to step S37, otherwise, the process ends.

In step S37, the display control module 504 controls the display screen 30 to display the test page of the electronic text file 101, and controls the display screen 30 to display a dialog box prompting the user to follow the display content displayed in the highlighted fashion to read. In the embodiment, the content of the test page includes a number of different portions, and each different portion of the test page is displayed on a display region with coordinates associated therewith.

In step S38, the camera 40 captures eye images of the user when the user focuses on each of the portions to read.

In step S39, the image processing module 501 extracts the eye feature values from the captured eye images of the user, and stores the extracted eye feature values and the coordinate corresponding to the respective extracted eye feature values in the posture feature database 102.

With such a configuration, when the text reading guide function of the electronic device 100 is activated, the display content corresponding to the coordinates of the display screen 30 being stared at by the user are executed special treatment and then displayed to the user. Thus, a vivid content displaying effect is presented to the user of the electronic device 100 when the user is reading the display screen 30, which makes viewing and reading convenient.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A text reading guide method for an electronic device, the electronic device comprising a display screen and a storage unit storing a database and at least one electronic text file, the database recording a plurality of feature values of images of eyes of a user, and a plurality of coordinates each corresponding to a display region of the display screen and being associated a corresponding feature value, the method comprising:
capturing a real-time eye image of eyes of a user;
extracting an eye image feature value from the captured eye image;
searching the database to find the eye image feature value of the user matching with the extracted eye image feature value of the user, and retrieving the coordinates associated with the eye image feature value recorded in the database;
determining the display content on the display region corresponding to the retrieved coordinates; and
displaying the determined contents in a highlight fashion on the display screen.

2. The method as described in claim 1, further comprising:
searching the database to find an eye image feature value with a highest similarity to the extracted eye image feature value of the user, and retrieving the coordinates associated with the eye image feature value recorded in the database, when the eye image feature value of the user matching with the extracted eye image feature value of the user is not found in the database.

3. The method as described in claim 1, wherein the highlight fashion is selected from the group consisting of enlarging the display content, coloring the display content, underlining the display content, and displaying the display content with a font different from the content in neighboring region.

4. The method as described in claim 1, further comprising:
displaying a test page of the electronic text file on the display screen, the content of the test page comprising a plurality of different portions, the display screen defining a coordinate system, each portion of the test page being displayed on a corresponding display region with coordinates associated therewith;
capturing eye images of the user when the user focuses on each of the portions; and
extracting the eye feature values from the captured eye images of the user, and storing the extracted eye feature values and the coordinate corresponding to the respective extracted eye feature values in the database.

5. The method as described in claim 4, further comprising displaying a dialog box on the display screen prompting the user to follow the display content displayed in the highlighted fashion.

6. The method as described in claim 4, wherein the highlight fashion is selected from the group consisting of enlarging the display content, coloring the display content, underlining the display content, and displaying the display content with a font different from the content in neighboring region.

7. An electronic device, comprising:
a display screen;
a storage unit storing a database and at least one electronic text file, the database recording at least one user's data and a plurality of coordinates, each user's data comprising a user name, a plurality of feature values of images of eyes of the user, and a plurality of coordinates each corresponding to a display region of the display screen and being associated a corresponding feature value;
an input unit, configured for activating a text reading guide function of the electronic device in response to the use's input operation;
a camera, configured to capture a real-time eye image of eyes of the user;
an image processing module, configured to extract eye an image feature value from the captured eye image;
an determining module, configured to search the database to find the eye image feature value of the user matching with the extracted eye image feature value of the user, and to retrieve the coordinates associated with the eye image feature value recorded in the database;
an effect control module, configured to determine the display content on the display region corresponding to the retrieved coordinates; and
a display control module, configured to control the display screen to display the determined contents in a highlight fashion.

8. The electronic device as described in claim 7, wherein the determining module is further configured to search the database to find an eye image feature value with a highest similarity to the extracted eye image feature value of the user, and to retrieve the coordinates associated with the eye image feature value recorded in the database, if the eye image feature value of the user matching with the extracted eye image feature value of the user is not found in the database.

9. The electronic device as described in claim 7, wherein:
the determining module is further configure to determine whether it is the first time for the user to activate the text reading guide function, and to determine whether the user agree to do a test for recording eye image feature values of his/her eyes' images, when it is the first time for the user to activate the text reading guide function; and
the effect control module is further configured to display a test page of the electronic text file on the display screen, the content of the test page comprising a plurality of different portions, the display screen defining a coordinate system, each portion of the test page being displayed on a corresponding display region with coordinates associated therewith;
the camera is further configure to capture eye images of the user when the user focuses on each of the portions; and
the image processing unit is further configured to extract the eye feature values from the captured eye images of the user, and to store the extracted eye feature values and the coordinate corresponding to the respective extracted eye feature values in the database.

10. The electronic device as described in claim 9, wherein the effect control module is further configured to display a dialog box on the display screen prompting the user to follow the display content displayed in the highlighted fashion.

11. The electronic device as described in claim 9, wherein highlight fashion is selected from the group consisting of enlarging the display content, coloring the display content, underlining the display content, and displaying the display content with a font different from the content in neighboring region.

12. The electronic device as described in claim 7, wherein the highlight fashion is selected from the group consisting of enlarging the display content, coloring the display content, underlining the display content, and displaying the display content with a font different from the content in neighboring region.

13. The electronic device as described in claim 7, being an electronic reader.
